(19) United States
(12) Patent Application Publication
(10) Pub. No.: US 2016/0113297 A1
(43) Pub. Date: Apr. 28, 2016

(54) FOOD SECURING DEVICE

(71) Applicant: Daniel Scott Dyer, Albion, MI (US)

(72) Inventor: Daniel Scott Dyer, Albion, MI (US)

(21) Appl. No.: 14/523,882

(22) Filed: Oct. 25, 2014

(51) Int. Cl. A22C 17/02; A47J 47/00

(52) U.S. Cl. CPC A22C 17/02; A47J 47/005

(57) ABSTRACT

FOOD SECURING DEVICE consisting of a plastic pick which is secured to a plastic base with an adhesive bottom; allowing a food item to be impaled on to the pick; while the base of the plastic pick remains secured to a surface keeping the pick and food item in place.

### BACKGROUND OF THE INVENTION

Oftentimes when preparing and cutting food, the item can slide and move, making it difficult to cut. The item can also slide and move when transported. It is therefore an object of the present invention to introduce an apparatus for a stick to temporarily secure food items from sliding, slipping and/or tipping while transported, displayed, carried or otherwise set in motion.

### BRIEF DESCRIPTION OF THE DRAWINGS

FIG. 1 is a side photograph of the present invention in use with a potato.

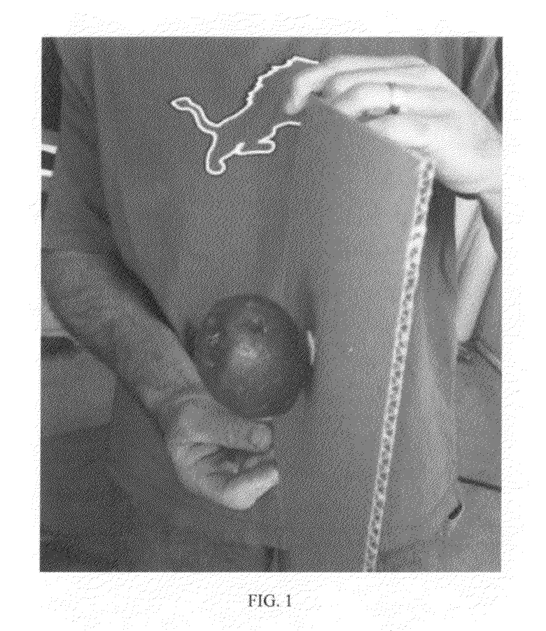

FIG. 2 is a front-side photograph of the present invention in use with the potato.

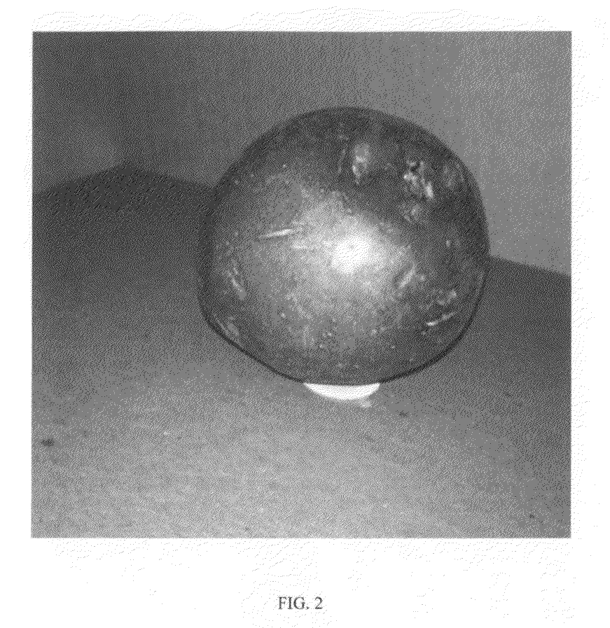

FIG. 3 is a top view photograph of the present invention with measurement.

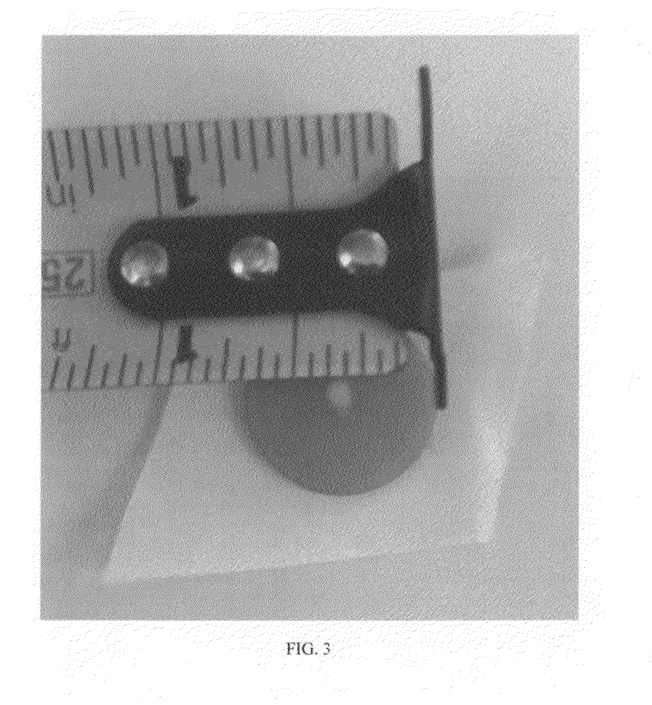

FIG. 4 is a side photograph of the present invention with measurement.

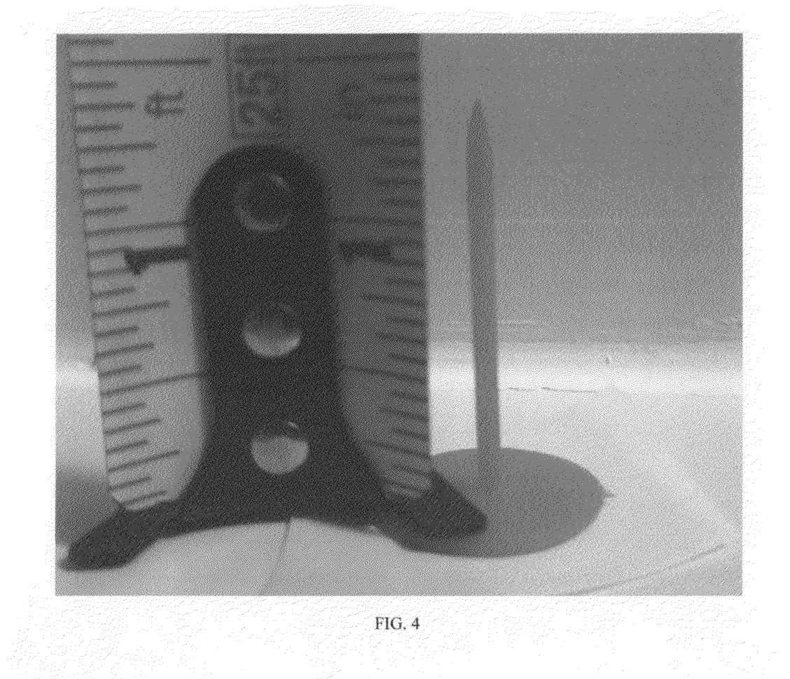

FIG. 5 is a dimensioned drawing of the present invention.

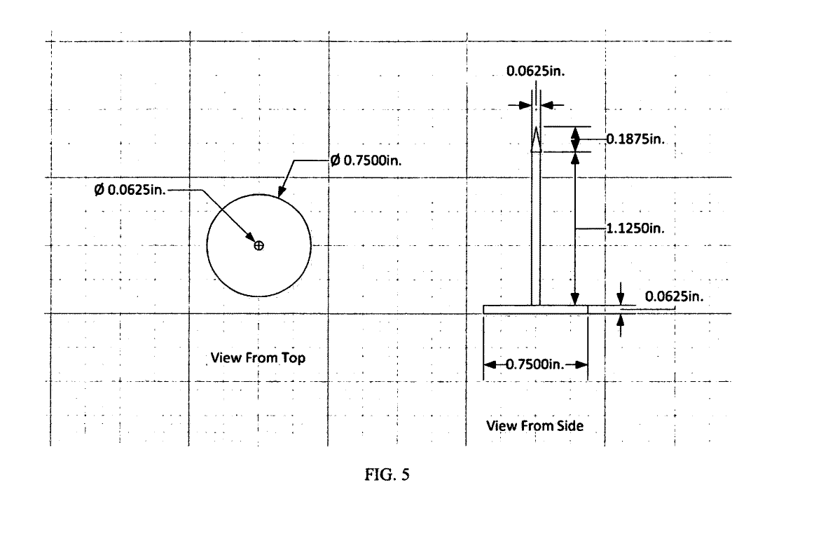

FIG. 6 is a side photograph showing the present invention by itself.

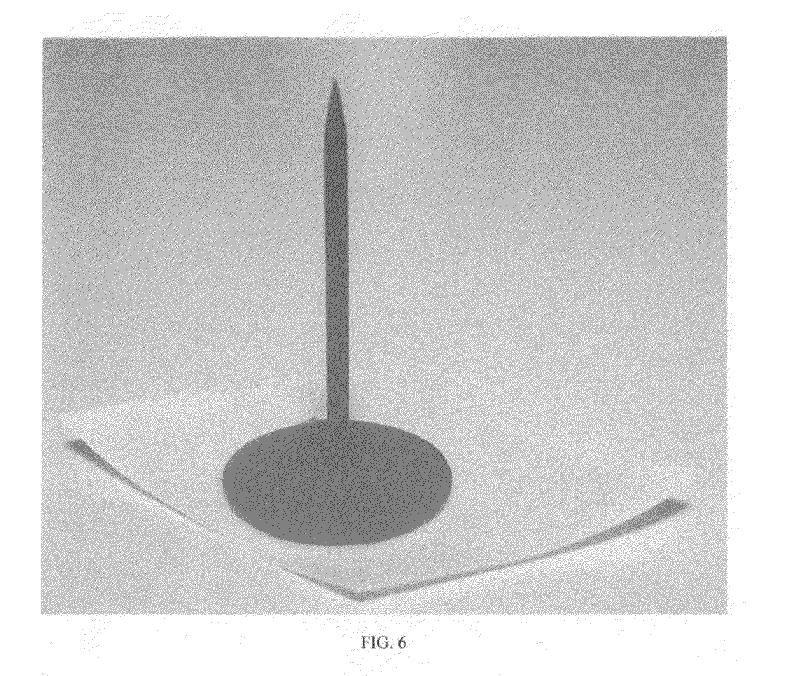

FIG. 7 is a photograph shows the adhesive between the plastic and tape of the present invention.

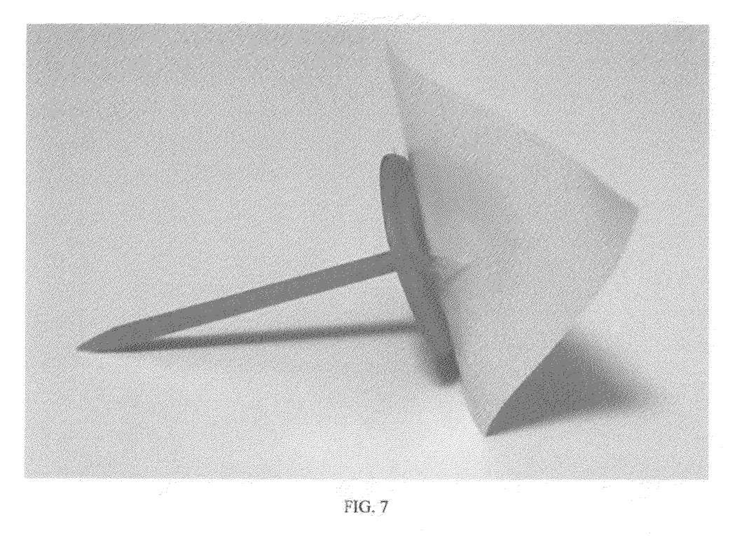

FIG. 8 is showing the adhesive on the bottom once tape is removed from the present invention.

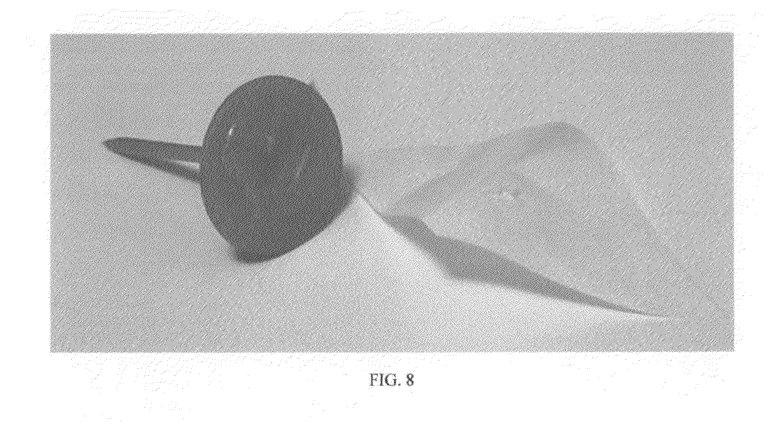

### DETAIL DESCRIPTIONS OF THE INVENTION

All illustrations of the drawings are for the purpose of describing selected versions of the present invention and are not intended to limit the scope of the present invention.

The present invention is an apparatus for a stick to temporarily secure food items from sliding, slipping and/or tipping while transported, displayed, carried or otherwise set in motion. The present invention is a device that utilizes a food safe spear/pick, which is secured to a base or surface; with the pick/spear inserted into the food item. The present invention is a food-safe plastic device with a round base that will help hold food items in place by utilizing one or more picks/spears. Adhesive on the bottom of the base secures the device to a surface.

Although the invention has been explained in relation to its preferred embodiment, it is to be understood that many other possible modifications and variations can be made without departing from the spirit and scope of the invention as hereinafter claimed.

### REFERENCES

Provisional Patent Application No. 61/898,845

I claim:

1. An apparatus, comprising a base and a pick; the base having a generally flat shape with an adhesive to secure it to a surface; with an attached pick protruding upward and to a point; the point being able to pierce food;
wherein the food is secured to the surface by way of the apparatus.

2. The apparatus of claim 1, wherein the base of the apparatus has a surface area relative of the pick.

3. The apparatus of claim 1, wherein the pick of the apparatus has a length relative to the base.

4. The apparatus of claim 1, wherein the adhesive attaches to the base.

5. The base of claim 2, wherein an adhesive is applied.

6. The pick of claim 3, wherein the pick is centrally attached to the base.

7. The adhesive of claim 4, wherein attaches the base to a surface.

8. The apparatus of claim 1, wherein the base, adhesive and pick form one device, used to secure food to a surface.

9. The apparatus of claim 1, comprising a food safe plastic.
